(19) United States
(12) Patent Application Publication
(10) Pub. No.: US 2009/0000296 A1
(43) Pub. Date: Jan. 1, 2009

(54) Turbocharger having divided housing with integral valve

(76) Inventors: David Andrew Pierpont, Dunlap, IL (US); Paul William Reisdorf, Dunlap, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/819,780

(22) Filed: Jun. 29, 2007

(51) Int. Cl. F02B 33/44; F01D 5/24

(52) U.S. Cl. 60/602; 415/116; 415/182.1

(57) ABSTRACT

A turbocharger is provided having a turbine wheel and a housing configured to at least partially enclose the turbine wheel. The housing may have a first turbine volute including a first inlet and a second turbine volute having a second inlet. The first and second volutes may be configured to communicate a first and second fluid flow with the turbine wheel. The housing may also have a wall member axially separating the first and second turbine volutes. In addition, the housing may have a valve configured to selectively allow fluid in the first inlet to communicate with fluid in the second inlet.

### TECHNICAL FIELD

The present disclosure is directed to a turbocharger and, more particularly, to a turbocharger having a divided housing with an integral valve.

### BACKGROUND

Internal combustion engines such as, for example, diesel engines, gasoline engines, and gaseous fuel powered engines are supplied with a mixture of air and fuel for subsequent combustion within the engine that generates a mechanical power output. In order to maximize the power generated by this combustion process, the engine is often equipped with a divided exhaust manifold in fluid communication with a turbocharged air induction system.

The divided exhaust system increases the engine power by helping to preserve the exhaust pulse energy generated by the engine cylinders. Preserving the exhaust pulse energy generated by the engine cylinders improves the turbocharger efficiency, which results in a more efficient use of fuel and ultimately a greater engine power output. In addition, the turbocharged air induction system increases the engine power by enhancing fueling. Such fueling is enhanced by increasing the supply of air to the engine combustion chambers. In particular, a typical turbocharged air induction system includes a turbocharger that uses exhaust from the engine to compress air flowing into the engine intake, thereby forcing more air into an engine combustion chamber than would otherwise be possible. This enhanced fueling increases the power generated by the engine.

In addition to the goal of maximizing engine power, it is desired to minimize exhaust emissions. The above-mentioned engines may exhaust a complex mixture of air pollutants composed of solid particulate matter and gaseous compounds including nitrous oxides (NOx). Due to increased attention on the environment, exhaust emission standards have become more stringent, and the amount of solid particulate matter and gaseous compounds emitted to the atmosphere from an engine is regulated depending on the type of engine, size of engine, and/or class of engine.

One method that has been implemented by engine manufacturers to comply with the regulation of these engine emissions includes utilizing an exhaust gas recirculating (EGR) system. EGR systems operate by recirculating a portion of the exhaust gas back to the intake of the engine. There, the exhaust gas mixes with fresh air. The resulting mixture contains less oxygen than pure air, thereby lowering the combustion temperature in the combustion chambers and producing less NOx. Simultaneously, some of the particulate matter contained within the exhaust is burned upon re-introduction to the combustion chamber.

EGR systems require a certain level of backpressure in the exhaust system to redirect the desired amount of exhaust gas back to the intake of the engine. The amount of backpressure needed for adequate operation of the EGR system varies with engine load. However, such backpressure adversely affects the turbocharger efficiency, thereby reducing the air compressing capability of the turbocharged air induction system. The reduced air compressing capability may in turn reduce the engine's fuel economy and possibly the amount of power generated by the engine.

U.S. Pat. No. 6,694,735 to Sumser et al. (“the '735 patent”) discloses an engine exhaust system utilizing and EGR circuit and a divided exhaust manifold in fluid communication with a turbocharged air induction system. The turbocharger includes a turbine fluidly connected to an exhaust manifold of the engine and a compressor mechanically connected to the turbine. Exhaust gas flows from the engine exhaust manifold to the turbine through a first and a second exhaust line. The first exhaust line is fluidly connected to the EGR circuit. In addition, the turbine includes three inlet passages having different sizes. The two smaller inlet passages fluidly communicate with the first exhaust line, and the largest inlet passage fluidly communicates with the second exhaust line. The first exhaust line further includes a throttling valve, which regulates the mass flow of exhaust gas flowing through the two smaller inlet passages. By actuating the valve, the backpressure in the first exhaust line can be adjusted, and the mass flow of exhaust gas flowing through the EGR circuit may be regulated.

Although the system in the '735 patent may adjust the backpressure in the turbocharger inlet passages to reduce adverse effects that the backpressure may have on turbocharger efficiency, the engine system design may offset any benefits gained from the backpressure adjustments. In particular, the flow rates of the exhaust gas flowing through the three inlet passages are not equal. Such discrepancies between flow rates may interfere with the energy generated by the cylinders and reduce the power output of the turbine and the overall efficiency of the turbocharger. The lower turbine power output and turbocharger efficiency may decrease the amount of air available for combustion by the engine and ultimately reduce the fuel economy and amount of power generated by the engine.

In addition, the system in the '735 patent uses a three turbocharger inlet passage configuration instead of the two inlet passage configuration used by conventional turbochargers. Moreover, each inlet passage has a unique cross-sectional shape and area. The additional inlet passage in conjunction with the complex design may create manufacturing issues and increase the manufacturing costs.

The disclosed system is directed to overcoming one or more of the problems set forth above.

### SUMMARY OF THE INVENTION

In one aspect, the disclosure is directed toward a turbocharger. The turbocharger may include a turbine wheel and a housing configured to at least partially enclose the turbine wheel. The housing may include a first turbine volute having a first inlet and a second turbine volute having a second inlet. The first and second volutes may be configured to communicate first and second fluid flows with the turbine wheel. The housing may also include a wall member axially separating the first and second turbine volutes. In addition, the housing may include a valve configured to selectively allow fluid in the first inlet to communicate with fluid in the second inlet.

Consistent with a further aspect of the disclosure, a method is provided for operating a turbocharger. The method includes simultaneously receiving a plurality of exhaust flows into the turbocharger at separate axially offset locations. The method also includes selectively allowing the exhaust flows to communicate with each other upon entering the turbine.

### BRIEF DESCRIPTION OF THE DRAWINGS

FIG. 1 is a schematic illustration of an exemplary disclosed power system;

FIG. 2 is an oblique view cutaway illustration of an exemplary disclosed turbocharger for use with the power system of FIG. 1; and

FIG. 3 is a side view cross-sectional illustration of the turbocharger of FIG. 2.

### DETAILED DESCRIPTION

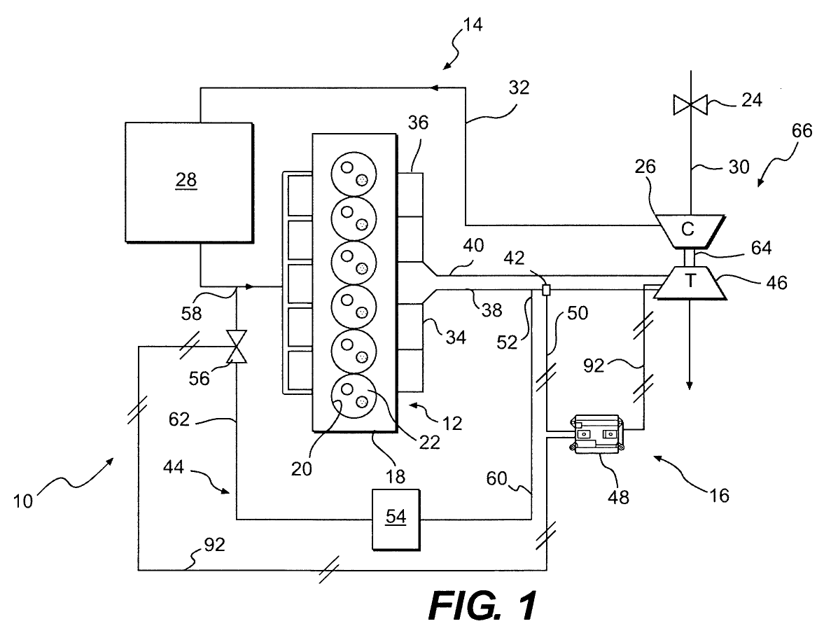

FIG. 1 illustrates a power system 10 having a power source 12, an air induction system 14, and an exhaust system 16. For the purposes of this disclosure, power source 12 is depicted and described as a four-stroke diesel engine. One skilled in the art will recognize, however, that power source 12 may be any other type of internal combustion engine such as, for example, a gasoline or a gaseous fuel-powered engine. Power source 12 may include an engine block 18 that defines a plurality of cylinders 20. A piston (not shown) may be slidably disposed within each cylinder 20 to reciprocate between a top-dead-center position and a bottom-dead-center position, and a cylinder head (not shown) may be associated with each cylinder 20.

Cylinder 20, the piston, and the cylinder head may form a combustion chamber 22. In the illustrated embodiment, power source 12 includes six such combustion chambers 22. However, it is contemplated that power source 12 may include a greater or lesser number of combustion chambers 22 and that combustion chambers 22 may be disposed in an “in-line” configuration, a “V” configuration, or in any other suitable configuration.

Air induction system 14 may include components configured to introduce charged air into power source 12. For example, air induction system 14 may include an induction valve 24, one or more compressors 26, and an air cooler 28. It is contemplated that additional components may be included within air induction system 14 such as, for example, additional valving, one or more air cleaners, one or more waste gates, a control system, a bypass circuit, and other means for introducing charged air into power source 12. It is also contemplated that induction valve 24 and/or air cooler 28 may be omitted, if desired.

Induction valve 24 may be connected to compressors 26 via a fluid passageway 30 and configured to regulate the flow of atmospheric air to power source 12. Induction valve 24 may embody a shutter valve, a butterfly valve, a diaphragm valve, a gate valve, or any other type of valve known in the art. Induction valve 24 may be solenoid-actuated, hydraulically-actuated, pneumatically-actuated, or actuated in any other manner in response to one or more predetermined conditions.

Compressor 26 may be configured to compress the air flowing into power source 12 to a predetermined pressure level. Compressors 26, if more than one is included within air induction system 14, may be disposed in a series or parallel relationship and connected to power source 12 via a fluid passageway 32. Compressor 26 may embody a fixed geometry compressor, a variable geometry compressor, or any other type of compressor known in the art. It is contemplated that a portion of the compressed air from compressor 26 may be diverted from fluid passageway 32 for other uses, if desired.

Air cooler 28 may embody an air-to-air heat exchanger, an air-to-liquid heat exchanger, or a combination of both, and be configured to facilitate the transfer of thermal energy to or from the compressed air directed into power source 12. For example, air cooler 28 may include a shell and tube-type heat exchanger, a corrugated plate-type heat exchanger, a tube and fin-type heat exchanger, or any other type of heat exchanger known in the art. Air cooler 28 may be disposed within fluid passageway 32, between compressor 26 and power source 12.

Exhaust system 16 may direct exhaust flow out of power source 12 and may include first and second exhaust manifolds 34 and 36, first and second exhaust passageways 38 and 40, one or more sensors 42 for sensing a condition in exhaust passageway 38, exhaust gas recirculation (EGR) loop 44, one or more turbines 46, and a controller 48 for regulating the flow of exhaust through exhaust system 16. It is contemplated that exhaust system 16 may include additional components such as, for example, particulate traps, NOx absorbers or other catalytic devices, attenuation devices, and other means for directing exhaust flow out of power source 12 that are known in the art.

The exhaust produced during the combustion process within combustion chambers 22 may exit power source 12 via either first exhaust manifold 34 or second exhaust manifold 36. First exhaust manifold 34 may be fluidly connected with exhaust passageway 38 such that the exhaust from a first group of combustion chambers 22 of power source 12 firing at nearly the same time may be directed through exhaust passageway 38 to turbine 46. Second exhaust manifold 36 may be fluidly connected with exhaust passageway 40 such that the exhaust from a second group of combustion chambers 22 of power source 12 firing at nearly the same time, but different from the first group, may be directed through exhaust passageway 40 to turbine 46. It should be understood that the cross-sectional area of exhaust passage 38 may be smaller than the cross-sectional area of exhaust passage 40. The smaller cross-sectional area may restrict the flow of exhaust gas through exhaust passage 38, thereby creating enough backpressure to direct at least a portion of the exhaust gas through EGR loop 44.

Sensor 42 may be located anywhere within exhaust passage 38 and may include one or more pressure sensing devices for sensing a pressure of the exhaust gas flowing through exhaust passage 38. Upon measuring the pressure of the exhaust gas, sensor 42 may generate an exhaust gas pressure signal and send this signal to controller 48 via communication line 50, as is known in the art. The signal may be used by controller 48 to adjust the backpressure in exhaust passageway 38. Alternately, it is contemplated that sensor 42 may be any type of mass air flow sensor such as, for example, a hot wire anemometer or a venturi-type sensor configured to sense the flow rate of exhaust gas passing through exhaust passageway 38. Controller 48 may use the sensed flow rate to determine and adjust the backpressure in exhaust passageway 38. The adjustment of pressure will be further explained later.

EGR loop 44 may include components that cooperate to redirect a portion of the exhaust provided by engine 12 from exhaust passageway 38 to fluid passageway 32. Specifically, EGR loop 44 may include an inlet port 52, an EGR cooler 54, a recirculation valve 56, and a discharge port 58. Inlet port 52 may be fluidly connected to first exhaust passageway 38 upstream of turbine 46 and fluidly connected to EGR cooler 54 via a fluid passageway 60. In addition, discharge port 58 may be fluidly connected to EGR cooler 54 via a fluid passageway 62. Recirculation valve 56 may be disposed within fluid passageway 62, between EGR cooler 54 and discharger port 58. It is contemplated that inlet port 52 may be located upstream or downstream of any turbochargers present (if any) and/or additional emission control devices disposed within first exhaust passageway 38 (not shown) such as, for example, particulate filters and catalytic devices.

Recirculation valve 56 may be located to regulate the flow of exhaust gas through EGR loop 44. Recirculation valve 56 may be any type of valve such as, for example, a butterfly valve, a diaphragm valve, a gate valve, a ball valve, a globe valve, or any other valve known in the art. In addition, recirculation valve 56 may be solenoid-actuated, hydraulically-actuated, pneumatically-actuated or actuated in any other manner to selectively restrict the flow of exhaust gas through fluid passageways 60 and 62.

EGR cooler 54 may be configured to cool exhaust gas flowing through EGR loop 44. EGR cooler 54 may include a liquid-to-air heat exchanger, an air-to-air heat exchanger, or any other type of heat exchanger known in the art for cooling an exhaust flow. It is contemplated that EGR cooler 54 may be omitted, if desired.

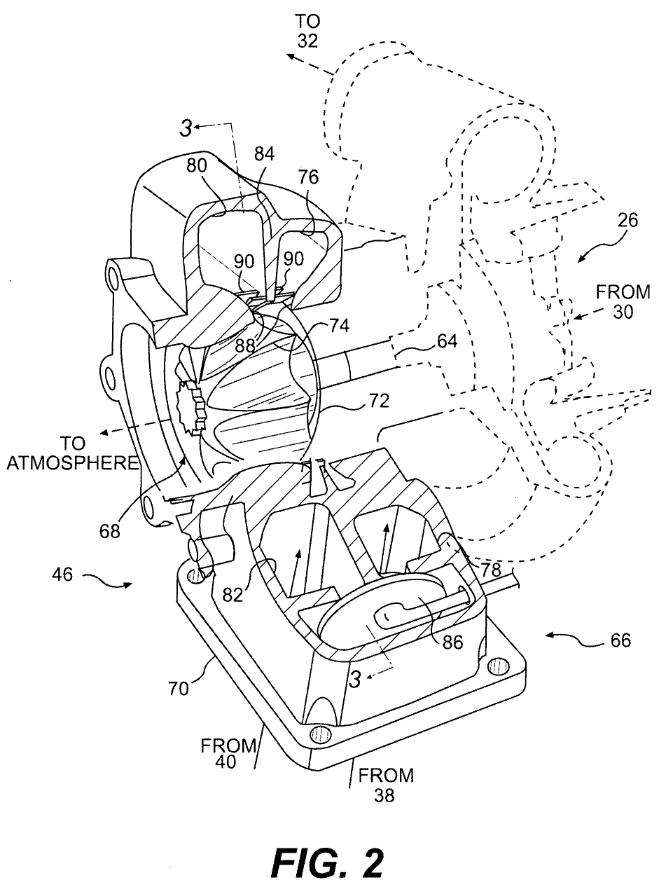

Turbine 46 may be configured to drive compressor 26. In addition, turbines 46, if more than one is included within exhaust system 16, may be disposed in a series or parallel relationship and connected to first and second exhaust manifolds 34 and 36 via first and second exhaust passageways 38 and 40. Each turbine 46 may be connected to one or more compressors 26 of air induction system 14 by way of a common shaft 64 to form a turbocharger 66. As the hot exhaust gases exiting power source 12 move through first and/or second exhaust passageways 38 and 40 to turbine 46 and expand against blades (not shown in FIG. 1) of turbine 46, turbine 46 may rotate and drive the connected compressor 26 to compress inlet air. As illustrated in FIG. 2, turbine 46 may include a turbine wheel 68 fixedly connected to common shaft 64 and centrally disposed to rotate within a turbine housing 70.

Turbine wheel 68 may include a turbine wheel base 72 and a plurality of turbine blades 74. Turbine blades 74 may be disposed on the outer periphery of turbine wheel base 72 and may be adapted to rotate turbine wheel base 72 when driven by the expansion of hot exhaust gases. Turbine blades 74 may be rigidly fixed to the turbine wheel base 72 using conventional means or may alternatively be integral with turbine wheel base 72 and be formed through a casting or forging process, if desired.

Turbine housing 70 may be configured to at least partially enclose turbine wheel 68 and direct hot expanding gases from first and second exhaust passageways 38 and 48 separately to turbine wheel 68. In particular, turbine housing 70 may be a divided housing have a first volute 76 with a first inlet 78 fluidly connected with exhaust passageway 38 and a second volute 80 fluidly with a second inlet 82 connected with exhaust passageway 40. A wall member 84 may divide first volute 76 from second volute 80. It should be understood that first volute 76 and first inlet 78 may have a smaller cross-sectional area than second volute 80 and second inlet 82 respectively.

Turbine housing 70 may also include a control valve 86 fluidly connected to both first inlet 78 and second inlet 82. Control valve 86 may be configured to regulate the pressure of exhaust gas flowing through exhaust passage 38 by selectively allowing exhaust gas to flow from the higher pressure first inlet 78 to the lower pressure second inlet 82. It should be understood that the amount of pressure in exhaust passage 38 may control the amount of exhaust gas directed through EGR loop 44. Because control valve 86 may ultimately control the amount of exhaust gas directed through EGR loop 44, it is contemplated that EGR valve 56 may be omitted, if desired. In addition, because exhaust gas may be selectively allowed to flow from first inlet 78 to second inlet 82, the differential between the flow rates in first and second volutes 76 and 80 may be minimized, thereby minimizing the impact the pressure differential may have on the turbocharger efficiency.

Control valve 86 may be any type of valve such as, for example, a butterfly valve, a diaphragm valve, a gate valve, a ball valve, a globe valve, or any other valve known in the art. Furthermore, control valve 86 may be solenoid-actuated, hydraulically-actuated, pneumatically-actuated or actuated in any other manner to selectively restrict the flow of exhaust gas between first and second inlets 78 and 82.

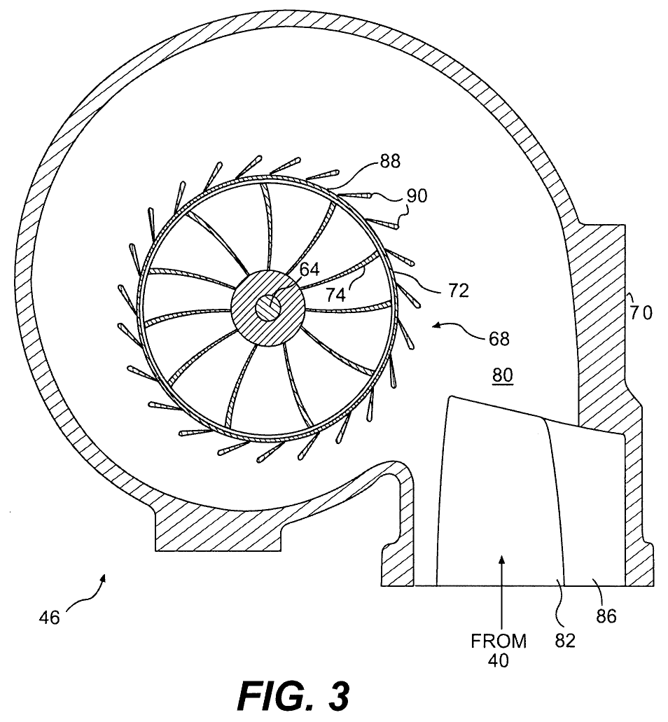

Each of first and second volutes 76, 80 may have an annular channel-like outlet 88 fluidly connecting first and second volutes 76, 80 with a periphery of turbine wheel 68. A plurality of vane members 90 may be disposed within each of first and second volutes 76, 80 between first and second inlets 78, 82 and annular channel-like outlet 88. Vane members 90 may be substantially equally angled relative to a central axis of turbine 46 such that exhaust gases entering first and second inlets 78, 82 and flowing annularly through first and second volutes 76, 80 may be radially and uniformly redirected inward through annular channel-like outlet 88 at a plurality of finite annular locations. As illustrated in both FIGS. 2 and 3, vane members 90 may be fixedly connected to opposing sides of wall member 84 at a plurality of equally spaced locations, thereby dividing annular channel-like outlet 88 into the plurality of finite outlet locations. It is contemplated that vane members 90 may be cast integrally with turbine housing 70 and fabricated, for example, through an electron discharge machining process. It is also contemplated that vane members 90 may alternatively be cast integrally with turbine housing 70 in finish form through a high precision casting process. It is further contemplated that vane members 88 may be initially separate from turbine housing 70 and, when assembled thereto, may be common to both first and second volutes 76, 80 (e.g., extending through wall member 84). It is additionally contemplated that vane members 90 may only be associated with only one of first and second volutes 76, 80, if desired.

Referring back to FIG. 1, controller 48 may regulate the flow rate of exhaust gas flowing through EGR loop 44 and the flow rate or pressure of exhaust gas flowing though exhaust passageway 38 by adjusting EGR valve 56 and/or control valve 86. It should be understood that controller 48 may adjust EGR valve 56 and/or control valve 86 by transmitting control signals via communication lines 92. For configurations omitting EGR valve 56, controller 48 may adjust only control valve 86 to regulate the flow of exhaust gas in EGR loop 44. In addition, the communication line 92 that runs from controller 48 to EGR valve 56 may be omitted.

Controller 48 may include one or more microprocessors, a memory, a data storage device, a communication hub, and/or other components known in the art and may be associated with exhaust system 16. It is contemplated that controller 48 may be integrated within a general control system capable of controlling additional functions of power system 10, e.g., selective control of power source 12, and/or additional systems operatively associated with power system 10, e.g., selective control of a transmission system (not shown).

Before regulating the flow of exhaust gas through EGR loop 44, controller 48 may receive data indicative of a condition of power source 12 or a desired exhaust gas flow rate through EGR loop 44. Such data may be received from another controller or computer (not shown). In an alternate embodiment, data indicative of condition of power source 12 may be received from sensors strategically located throughout power system 10. Controller 48 may compare the power source condition data to algorithms, equations, subroutines, reference look-up maps or tables and determine a desired exhaust gas flow rate through EGR loop 44.

Controller 48 may also receive signals from sensor 42 indicative of the flow rate or pressure of exhaust gas flowing through exhaust passageway 38. Upon receiving input signals from sensor 42, controller 48 may perform a plurality of operations, e.g., algorithms, equations, subroutines, reference look-up maps or tables to determine whether the flow rate or pressure of exhaust gas flowing through exhaust passageway 38 is within a desired range for producing the desired exhaust gas flow rate through EGR loop 44. In an alternate embodiment, it is contemplated that controller 48 may receive signals from various sensors (not shown) located throughout exhaust system 16 and/or power system 10 instead of sensor 42. Such sensors may sense parameters that may be used to calculate the flow rate or pressure of exhaust gas flowing through exhaust passageway 38.

### INDUSTRIAL APPLICABILITY

The disclosed turbocharger may be implemented into any power system application where charged air induction and exhaust gas recirculation are utilized. In particular, because the disclosed turbocharger includes an integral control valve, the air system efficiency and fuel economy may be improved while reducing the amount of emissions released into the atmosphere. The operation of power system 10 will now be explained.

Referring to FIG. 1, atmospheric air may be drawn into air induction system 14 by compressor 26 via induction valve 24, where it may be pressurized to a predetermined level before entering combustion chambers 22 of power source 10. Fuel may be mixed with the pressurized air before or after entering combustion chambers 22 and combusted by power source 10 to produce mechanical work and an exhaust flow of hot gases. After being combusted the exhaust gas may enter either first exhaust manifold 34 or second exhaust manifold 36 depending on the configuration of combustion chambers 22.

Exhaust from exhaust manifold 34 may flow through exhaust passageway 38, and exhaust from exhaust manifold 36 may flow through exhaust passageway 40. Because exhaust passageway 38 may have a smaller cross-sectional area than exhaust passageway 40, exhaust gas flowing through exhaust passageway 38 may have a higher pressure and/or a lower flow rate than exhaust gas flowing through exhaust passageway 40. The higher pressure in exhaust passageway 38 may allow at least a portion of the exhaust gas to flow through EGR loop 44. Controller 48 may regulate the flow rate of exhaust gas flowing through EGR loop 44 by adjusting EGR valve 56 and/or control valve 86. Such adjustments may be made in response to an operating condition of power source 12 and a sensed flow rate or pressure of exhaust gas flowing through exhaust passage 38. In addition, it is contemplated that control valve 86 may be adjusted in small increments, if desired.

The portion of exhaust gas that is not flowing through EGR loop 44 may be directed to turbine 46 where the expansion of the hot gases may cause turbine 46 to rotate, thereby rotating connected compressor 26 and compressing the inlet air. After exiting turbine 46, the exhaust flow may flow through additional exhaust treatment devices and be released to the atmosphere.

As illustrated in FIG. 2, as the exhaust gases flowing from power source 10 enter turbine 46 via exhaust passageways 38 and 40, they may be separately and simultaneously directed through first and second volutes 76, 80, respectively, to turbine wheel 68. Also, depending upon the position of control valve 86, at least a portion of exhaust gas flowing through first inlet 78 may flow through second inlet 82, thereby reducing the pressure and flow rate differential between first and second volutes 76 and 80. As the flow of exhaust moves through each of first and second volutes 76, 80 and around turbine wheel 68, vane members 90 may redirect these annular flows inward to the periphery of turbine blades 74 at the plurality of finite locations. After imparting energy to and thereby urging turbine blades 74 to rotate, the exhaust gases may axially exit turbine 46.

The advantages of integral control valve 86 may be realized in the disclosed power system. In particular, because the turbine includes an integral control valve, the differential between of the flow rates of exhaust gas flowing through the first and second volutes may be minimized. By minimizing the flow rate differential, a larger portion of the energy generated by the cylinders may be preserved, thereby increasing the power output of the turbine and the overall efficiency of the turbocharger. The increased turbine power output and turbocharger efficiency may increase the amount of air available for combustion by the engine and ultimately increase the fuel economy and amount of power generated by the engine.

In addition, the design of the turbine may be simpler because it uses only two inlet passages. The simpler design may minimize manufacturing issues and decrease manufacturing costs.

It will be apparent to those skilled in the art that various modifications and variations can be made to the disclosed turbocharger. Other embodiments will be apparent to those skilled in the art from consideration of the specification and practice of the disclosed turbocharger. It is intended that the specification and examples be considered as exemplary only, with a true scope being indicated by the following claims and their equivalents.

What is claimed is:

1. A turbocharger, comprising:
a turbine wheel; and
a housing configured to at least partially enclose the turbine wheel and having:
a first turbine volute having a first inlet and configured to communicate a first fluid flow with the turbine wheel;
a second turbine volute having a second inlet and configured to communicate a second fluid flow with the turbine wheel;
a wall member axially separating the first and second turbine volutes; and
a valve configured to selectively allow fluid in the first inlet to communicate with fluid in the second inlet.

2. The turbocharger of claim 1, wherein the first volute has a smaller cross-sectional area than the second volute, and the first inlet has a smaller cross-sectional area than the second inlet.

3. The turbocharger of claim 2, wherein the housing further includes a first plurality of annularly disposed vane members associated with at least one of the first or second turbine volutes.

4. The turbocharger of claim 3, wherein the first plurality of annularly disposed vane members is associated with the first turbine volute and the housing further includes a second plurality of annularly disposed vane members associated with the second turbine volute.

5. The turbocharger of claim 2, further including a pressure sensor configured to sense a parameter indicative of a pressure of the exhaust flowing through the first inlet.

6. The turbocharger of claim 5, further including a controller configured to adjust the valve in response to the sensed exhaust pressure.

7. The turbocharger of claim 2, further including a flow sensor configured to sense a parameter indicative of a flow of the exhaust flowing through the first inlet.

8. The turbocharger of claim 7, further including a controller configured to adjust the valve in response to the sensed exhaust flow.

9. A method of operating a turbocharger, comprising:
simultaneously receiving a plurality of exhaust flows into the turbocharger at separate axially offset locations; and
selectively allowing the exhaust flows to communicate with each other upon entering the turbine.

10. The method of claim 9, wherein the exhaust flows have different flow rates or pressures.

11. The method of claim 10, further including sensing a flow rate or pressure of one of the exhaust flows and selectively allowing the plurality of exhaust flows to communicate with each other based on the sensed flow rate or pressure.

12. The method of claim 11, further including simultaneously and radially redirecting both of the first and second flows of exhaust at a plurality of finite annular locations.

13. The method of claim 12, wherein the annular locations are spaced substantially equally about the periphery of a turbine wheel.

14. A power system, comprising:
a power source having a plurality of combustion chambers and being configured to produce a power output and a flow of exhaust gases;
a first exhaust passageway associated with at least a first of the plurality of combustion chambers;
a second exhaust passageway associated with at least a second of the plurality of combustion chambers;
an exhaust gas recirculation loop configured to direct exhaust gas to an intake of the power source; and
a turbocharger in fluid communication with the first and second exhaust passageways, the turbocharger including:
a turbine wheel; and
a housing configured to at least partially enclose the turbine wheel and having:
a first turbine volute having a first inlet and configured to fluidly communicate exhaust with the turbine wheel;
a second turbine volute having a second inlet and configured to fluidly communicate exhaust with the turbine wheel;
a wall member axially separating the first and second turbine volutes; and
a valve configured to selectively allow exhaust in the first inlet to communicate with exhaust in the second inlet.

15. The power system of claim 14, wherein the first volute has a smaller cross-sectional area than the second volute, and the first inlet has a smaller cross-sectional area than the second inlet.

16. The power system of claim 15, wherein the first exhaust passageway is fluidly connected to the exhaust gas recirculation loop.

17. The power system of claim 16, further including a pressure sensor or flow rate sensor configured to sense a parameter indicative of a pressure of the exhaust flowing through the first inlet.

18. The power system of claim 17, further including a controller configured to adjust the valve in response to the sensed exhaust pressure or flow rate.

19. The power system of claim 18, wherein the housing further including a first plurality of annularly disposed vane members associated with at least one of the first and second turbine volutes.

20. The power system of claim 19, wherein the first plurality of annularly disposed vane members is associated with the first turbine volute and the housing further includes a second plurality of annularly disposed vane members associated with the second turbine volute.
